(19) United States
(12) Patent Application Publication
(10) Pub. No.: US 2022/0340152 A1
(43) Pub. Date: Oct. 27, 2022

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventors: Ji Heon Kwon, Seoul (KR); You Keun Kim, Uiwang-si (KR)

(73) Assignees: Hyundai Motor Company, Seoul (KR); KIA CORPORATION, Seoul (KR)

(21) Appl. No.: 17/567,324

(22) Filed: Jan. 3, 2022

(30) Foreign Application Priority Data
Apr. 23, 2021 (KR) 10-2021-0053019

(51) Int. Cl. B60W 50/02; G07C 5/08; G07C 5/00; B60R 16/023

(52) U.S. Cl. CPC B60W 50/0225; G07C 5/085; G07C 5/008; B60W 50/0205; B60R 16/0232

(57) ABSTRACT

Provided is a vehicle and a method of controlling the same that are capable of detecting a faulty ECU that fails to be switched to a sleep mode, and allowing the faulty ECU to be normally switched to the sleep mode through a rest of the faulty ECU. The method includes performing communication monitoring on a plurality of electronic control units (ECUs) connected to each other through a network; detecting a faulty ECU that does not enter a sleep mode under a sleep mode entry condition from among the plurality of ECUs based on a result of the communication monitoring; and performing a reset on the faulty ECU to allow the faulty ECU to enter the sleep mode.

### CROSS-REFERENCE TO RELATED APPLICATION

This application is based on and claims priority under 35 U.S.C. § 119 to Korean Patent Application No. 10-2021-0053019, filed on Apr. 23, 2021 in the Korean Intellectual Property Office, the disclosure of which is incorporated herein by reference.

### BACKGROUND

### 1. Technical Field

The disclosure relates to a vehicle, and more specifically, to a vehicle having a structure in which a plurality of electronic control units (ECUs) are connected through a communication network and a method of controlling the same.

### 2. Description of the Related Art

As vehicles are becoming more complex in the structure and equipped with various functions for the safety and convenience, a large number of electronic control units (ECU)s are installed so that each ECU is responsible for a given specific control. In such a structure, ECUs cooperate with each other or exchange required data by communicating with each other through a communication network.

As such, since a large number of ECUs are mounted in one vehicle, a great amount of electric power is consumed by the ECUs. In order to reduce the power consumption by the ECUs, the ECU may be switched to a sleep mode when the ECU is not operating so that power consumption may be reduced.

However, some specific ECUs may not normally enter a sleep mode due to an error. In particular, when a plurality of ECUs form one group and one ECU in the corresponding group does not normally switch to a sleep mode, the remaining ECUs in the corresponding group may not also switch to a sleep mode. The plurality of ECUs not being switched to a sleep mode may take power consumption of a battery, leading to a discharge of the battery.

The information disclosed in the Background section above is to aid in the understanding of the background of the present disclosure, and should not be taken as acknowledgement that this information forms any part of prior art.

### SUMMARY

The present disclosure provides a vehicle and a method of controlling the same that are capable of detecting a faulty ECU that fails to be switched to a sleep mode and allows the faulty ECU to be normally switched to a sleep mode by resetting the faulty ECU.

Additional aspects of the disclosure will be set forth in part in the description which follows and, in part, will be obvious from the description, or may be learned by practice of the disclosure.

According to an aspect of the disclosure, there is provided a method of controlling a vehicle, the method including: performing, by a controller, communication monitoring on a plurality of electronic control units (ECUs) connected to each other through a network; detecting, by the controller, a faulty ECU that does not enter a sleep mode under a sleep mode entry condition from among the plurality of ECUs based on a result of the communication monitoring; and performing, by the controller, a reset on the faulty ECU to allow the faulty ECU to enter the sleep mode.

An ECU that does not transmit a signal indicating a SLEEP value of a network management message or alternately transmits a signal indicating the SLEEP value and a signal indicating an ALIVE value of the network management message may be determined as the faulty ECU.

If the plurality of ECUs transmit a signal indicating a SLEEP value of a network management message and a last ECU among the plurality of ECUs does not transmit an ACK signal, the last ECU may be determined as the faulty ECU.

If at least one ECU among the plurality of ECUs repeats transmission and non-transmission of a network management message so that the plurality of ECUs repeatedly change to an ALIVE state for network reconfiguration therebetween, the at least one ECU may be determined as the faulty ECU.

The plurality of ECUs may form one ECU group, and the performing of the reset on the fault ECU may include performing a reset on all ECUs in the one ECU group to which the fault ECU belongs.

The performing of the reset on the fault ECU may include temporarily stopping a supply of power to reset target ECUs to be subject to the reset and then resuming the supply of power.

The method may further include, before the performing of the reset, transmitting a reset warning to a reset target ECU to be subject to the reset.

The method may further include, in response to the reset warning, allowing data of the reset target ECU to be stored.

The performing of the communication monitoring may be started when a preset communication monitoring start condition is satisfied.

The preset communication monitoring start condition may include: a state in which an engine of the vehicle is turned off; a state in which a door of a driver seat is closed after having been opened; a state in which all doors of the vehicle are locked; and a battery voltage of the vehicle is greater than or equal to a predetermined voltage.

According to another aspect of the disclosure, there is provided a vehicle including: a plurality of electronic control units (ECUs) connected to each other through a network to form one ECU group; and a controller configured to perform communication monitoring on the plurality of ECUs, detect a faulty ECU that does not enter a sleep mode under a sleep mode entry condition from among the plurality of ECUs based on a result of the communication monitoring, and perform a reset on the faulty ECU to allow the faulty ECU to enter the sleep mode.

The controller may be configured to determine an ECU that does not transmit a signal indicating a SLEEP value of a network management message or alternately transmits a signal indicating the SLEEP value and a signal indicating an ALIVE value of the network management message as the faulty ECU.

The controller may be configured to, if the plurality of ECUs transmit a signal indicating a SLEEP value of a network management message, and a last ECU among the plurality of ECUs does not transmit an ACK signal, determine the last ECU as the faulty ECU.

The controller may be configured to, if at least one ECU among the plurality of ECUs repeats transmission and non-transmission of a network management message so that the plurality of ECUs repeatedly change to an ALIVE state for network reconfiguration therebetween, determine the at least one ECU as the faulty ECU.

The reset on the faulty ECU may be performed by resetting all ECUs in the one ECU group to which the fault ECU belongs.

The reset on the faulty ECU may be performed by temporarily stopping a supply of power to reset target ECUs to be subject to the reset and then resuming the supply of power.

The controller may be configured to, before the reset, transmit a reset warning to a reset target ECU to be subject to the reset.

The controller may be configured to, in response to the reset warning, allow data of the reset target ECU to be stored.

The controller may be configured to perform the communication monitoring when a preset communication monitoring start condition is satisfied.

The preset communication monitoring start condition may include: a state in which an engine of the vehicle is turned off; a state in which a door of a driver seat is closed after having been opened; a state in which all doors of the vehicle are locked; and a battery voltage of the vehicle is greater than or equal to a predetermined voltage.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a diagram illustrating a configuration of a vehicle according to an embodiment of the disclosure;

FIG. 2 is a diagram illustrating a method of controlling a vehicle according to an embodiment of the disclosure;

FIG. 3 is a diagram illustrating a method of detecting an ECU of a first type of error;

FIG. 4 is a diagram illustrating network message values for each ECU and state information records during performance of the control method shown in FIG. 3;

FIG. 5 is a diagram showing a method of detecting an ECU of a second type of error;

FIG. 6 is a diagram illustrating network message values for each ECU and state information records during performance of the control method shown in FIG. 5;

FIG. 7 is a diagram showing a method of detecting an ECU of a third type of error;

FIG. 8 is a diagram illustrating records of information about ECUs that have not transmitted a network message during performance of the control method shown in FIG. 7; and

FIG. 9 is a diagram illustrating discharge prevention in a method of controlling a vehicle method according to an embodiment of the disclosure.

### DETAILED DESCRIPTION

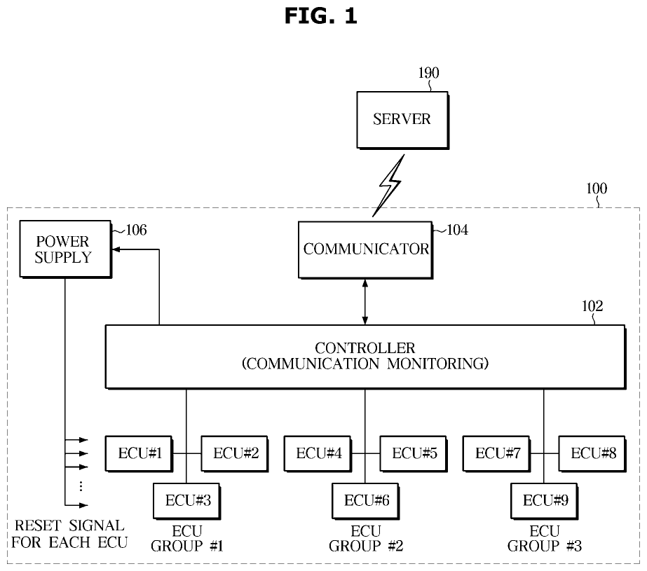

FIG. 1 is a diagram illustrating a configuration of a vehicle according to an embodiment of the disclosure. Referring to FIG. 1, a vehicle 100 according to an embodiment of the disclosure includes a controller 102, a communicator 104, and a power supply 106.

The controller 102 of the apparatus according to an exemplary embodiment of the present disclosure may be a processor (e.g., computer, microprocessor, CPU, ASIC, circuitry, logic circuits, etc.). The controller 102 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The controller 102 is provided to monitor communication states of a plurality of Electronic Control Units (ECUs) provided in the vehicle 100. The controller 102 may be a control unit. The controller 102 checks an operation state or communication state of each of the plurality of ECUs through a monitoring operation.

Although ECUs from ECU #1 to ECU #9 are shown in FIG. 1, the ECU of the vehicle 100 according to the embodiment of the disclosure is not limited thereto, and may include more (or fewer) ECUs. In addition, the plurality of ECUs may be divided based on a network used by the ECUs or a task given to the ECUs and grouped into a plurality of ECU groups including ECU group #1 to ECU group #3.

The communicator 104 allows communication to be performed between the controller 102 of the vehicle 100 and a server 190 at an outside (at a remote site). The controller 102 communicates with the server 190 through the communicator 104, to transmit monitoring information of the plurality of ECUs of the vehicle 100 to the server 190 and receive an analysis result of the monitoring information from the server 190.

The communicator 104 may be a hardware device implemented by various electronic circuits to transmit and receive signals via, e.g., wireless connections.

The power supply 106 is provided to supply power to various devices of the vehicle 100. In particular, the power supply 106 may reset the plurality of ECUs by generating a reset signal to the plurality of ECUs. The reset of the ECU is achieved by temporarily shutting off the supply of power to the ECU and then resuming the supply of power. The reset of the plurality of ECUs may be selectively performed on each of the plurality of ECUs. That is, a selective reset may be performed on one target ECU, some target ECUs, all ECUs of all ECUs in one target ECU group, or all ECUs provided in the vehicle 100. The reset of the ECU through the power supply 106 may be performed by a command from the controller 102.

The following description is made in relation to an example in which the ECU communication monitoring is performed on only one ECU group (e.g., ECU group #1) among the plurality of ECU groups shown in FIG. 1. As for the remaining ECU groups, i.e., ECU group #2 and ECU group #3, communication monitoring may be performed in the same manner as in the communication monitoring performed on ECU group #1.

In an ECU communication structure, to which a network management mode of a vehicle is applied, as shown in FIG. 1, in order for all ECUs constituting one ECU group to be switched to a SLEEP state, the following conditions need to be satisfied. That is, when all ECUs in a corresponding ECU group transmit a signal indicating a SLEEP value of a network management message, and then the last ECU transmits a response signal (an ACK signal), all ECUs in the corresponding ECU group enter a SLEEP state.

In a network employing a network management mode, all ECUs simultaneously enter a SLEEP state or simultaneously switch to a wake-up state. Therefore, even one faulty ECU may prevent all ECUs in the corresponding ECU group from entering a SLEEP state, and consume a power of a battery, causing a battery discharge.

That is, when a specific ECU in one ECU group does not transmit a SLEEP value of a network management message or alternately transmits a signal indicating a SLEEP value and a signal indicating an ALIVE value (the first type of error), all ECUs in the ECU group to which the ECU belongs do not enter a SLEEP state, which consumes the power of a battery. In addition, when all ECUs in one ECU group transmit a signal indicating a SLEEP value of a network management message, but the last ECU does not transmit an ACK signal (the second type of error), all ECUs in the corresponding ECU group do not switch to a SLEEP state, which consumes the power of a battery. In addition, when a specific ECU repeats transmission/non-transmission of a network management message and thus ECUs of the corresponding ECU group are repeatedly switched to an ALIVE state for network reconfiguration therebetween (the third type of error), all ECUs of the corresponding ECU group does not switch to a SLEEP state, which consumes the power of the battery.

When the battery is discharged, the supply of power to all ECUs is cut off, causing the ECUs to be turned off, and once the battery is recharged, all ECUs are in a state of being reset by an interruption of power followed by a supply of power, so the error phenomenon does not appear and the faulty ECU may not be identified. Therefore, there is a need to detect a faulty ECU that does not enter a SLEEP state and thus causes discharge for each type of error as described above, analyze the cause of the fault, and then reset the faulty ECU to prevent battery discharge.

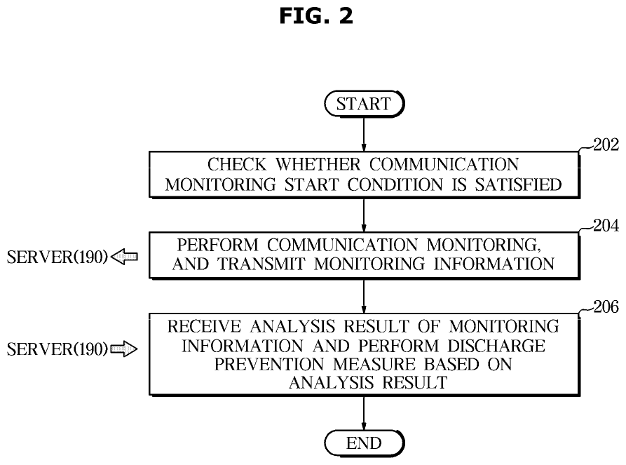

FIG. 2 is a diagram illustrating a method of controlling a vehicle according to an embodiment of the disclosure. The method shown in FIG. 2 includes monitoring an operation state or communication state of each of a plurality of ECUs provided in the vehicle 100, transmitting the result of the monitoring to the server 190, receiving an analysis result of monitoring information from the server 190, and performing a discharge preventive measure on the faulty ECU based on the received analysis result.

The controller 102 checks whether a predetermined monitoring start condition for performing communication monitoring on a plurality of ECUs is satisfied (202). That is, the controller 102 is provided with monitoring start conditions for performing communication monitoring, and the controller 102 performs communication monitoring on the plurality of ECUs when the monitoring start conditions are satisfied.

That is, in the embodiment of the disclosure, the controller 102 performs communication monitoring on the ECUs, upon satisfying all conditions that an engine of the vehicle 100 is turned off, a door of a driver seat is opened and then closed, all doors (including a trunk and a hood) of the vehicle 100 are locked, and a battery volte is equal to or greater than a predetermined voltage (e.g., 10V). The monitoring start conditions are conditions that ensure the safety of the vehicle 100 even after performing monitoring on the plurality of ECUs of the vehicle 100 and resetting some or all ECUs as needed. The monitoring start conditions are not limited thereto, and may further include other conditions that may ensure the safety of the vehicle 100.

When all of the predetermined monitoring start conditions are satisfied, the controller 102 performs communication monitoring in a predetermined process, and transmits a result of the communication monitoring, i.e., monitoring information, to the server 190 (204). The monitoring information may include information about an ECU (a faulty ECU) that has exhibited an abnormal operation in the communication monitoring among the plurality of ECUs. In the embodiment of the disclosure, the communication monitoring by the controller 102 may be performed for a predetermined period of time (e.g., forty minutes).

The monitoring information transmitted from the controller 102 of the vehicle 100 is analyzed by the server 190, and the analysis result is provided to the controller 102 of the vehicle 100. Based on the analysis result received from the server 190, the controller 102 of the vehicle 100 performs a discharge prevention measure on a corresponding ECU among the plurality of ECUs (206). The analyzing of the monitoring information performed by the server 190 may include analyzing a cause of the fault of the faulty ECU. The controller 102 of the vehicle 100 identifies the cause of the faulty of the faulty ECU from the analysis result of the server 190, and performs a discharge prevention measure on the corresponding ECU. The discharge prevention measure may include, for example, forcibly resetting the corresponding ECU such that the ECU may enter a SLEEP state when a switching to a SLEEP state is required.

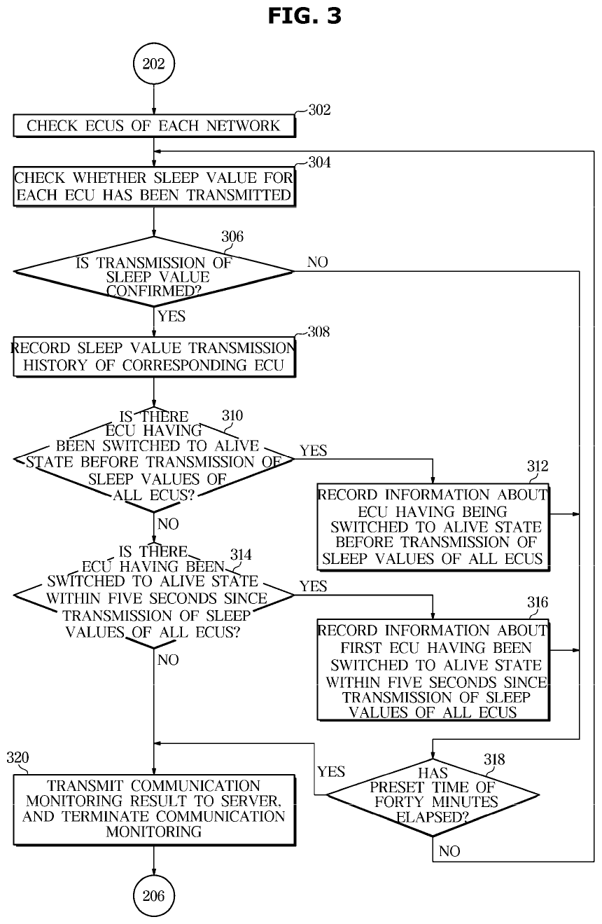

The method of controlling the vehicle according to the embodiment of the disclosure shown in FIG. 2 will be described in more detail with reference to FIGS. 3 to 9 to be described below.

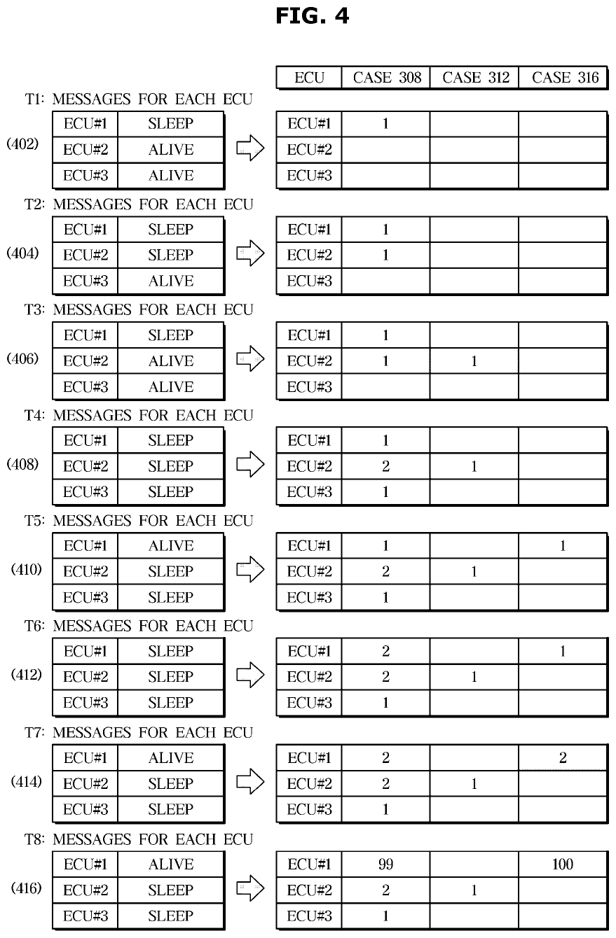

FIGS. 3 and 4 are diagrams illustrating an example of ‘performing a communication monitoring and transmitting monitoring information’ in the method of controlling the vehicle shown in FIG. 2. FIG. 3 is a diagram illustrating a method of detecting an ECU of a first type of error. That is, FIG. 3 shows a method of detecting a type of error in which a specific ECU in one ECU group does not transmit a signal indicating a SLEEP value of a network management message or alternately transmits a signal indicating a SLEEP value and a signal indicating an ALIVE value. FIG. 4 is a diagram illustrating network message values for each ECU and state information records during performance of the control method shown in FIG. 3.

Referring to FIG. 3, the controller 102 starts communication monitoring when all of the communication monitoring start conditions are satisfied, by checking ECUs of each network as a first task of the communication monitoring (302). That is, through monitoring of a network management message, the existence of ECUs for each network or ECUs constituting each ECU group is checked.

In response to presence of ECUs for each network, the controller 102 checks whether a SLEEP value for each ECU has been transmitted (304). First, the following description will be made in relation to an example in which the checking is performed on ECU #1 to ECU #3 of ECU group #1 shown in FIG. 1. That is, transmission of a SLEEP value is checked on each of ECU #1 to ECU #3 in ECU group #1.

Based on transmission of a SLEEP value of a specific ECU being confirmed (YES in 306), the controller 102 records a SLEEP value transmission history of the corresponding ECU (308). In FIG. 4, each number in item “CASE 308” represent the number of times that each of ECU #1 to ECU #3 in ECU group #1 has transmitted a SLEEP value. That is, whenever each ECU transmits a SLEEP value, the number of transmission times is recorded. With such a process, it is checked whether all ECUs in ECU group #1 transmit SLEEP values. Conversely, when the transmission of a SLEEP value for a specific ECU is not confirmed (No in 306), the controller 102 keeps checking a transmission of a SLEEP value of each ECU for a preset time (e.g., 40 minutes) allocated for the communication monitoring (518). Based on the preset time of forty minutes elapsing (YES in operation 718), the controller 102 transmits the communication monitoring result (i.e., monitoring information) obtained up to the present time to the server 190, and then terminates the communication monitoring (520).

The controller 102 checks whether there is an ECU that has been switched to an ALIVE state before all ECUs of the ECU group #1 transmit SLEEP values (310).

In response to presence of at least one ECU that has been switched to the ALIVE state before all ECUs transmit SLEEP values (YES in 310), the controller 102 records information about the ECU that has been switched to the ALIVE state (312). In FIG. 4, each number in item “CASE 312” represent the number of times that the at least one ECU has been switched to the ALIVE state before all of ECU #1 to ECU #3 of ECU group #1 transmit SLEEP values. That is, the controller 102, whenever at least one ECU switches to the ALIVE state before all ECUs transmit SLEEP values, records the relevant information, that is, the number of times that the at least one ECU has been switched to the ALIVE state. In this case, the number of occurrences of switching into the ALIVE state after transmission of a SLEEP value is not counted. Referring to FIG. 4, all ECUs finally transmit the SLEEP value in operation 408, but it can be seen that in operation 406, prior to operation 408, ECU #2 has been switched to the ALIVE state, and the number of occurrences of switching into the ALIVE state is recorded as ‘1’.

Conversely, upon confirming the absence of an ECU that has been switched to the ALIVE state before all ECUs transmit SLEEP values (No in operation 310), the controller 102 checks existence of an ECU that has been switched to the ALIVE state within a preset time (e.g., five seconds) since transmission of SLEEP values of all ECUs (314).

In response to presence of an ECU that has been switched to the ALIVE state within the preset time (e.g., five seconds) since the transmission of the SLEEP values of all ECUs (YES in operation 314), the controller 102 records information about an ECU that has been switched to the ALIVE state first among the corresponding ECUs (316). In FIG. 4, each number of item “CASE 316” is the number of occurrences of switching into the ALIVE state within a preset time of five seconds since the transmission of the SLEEP values of all of ECU #1 to ECU #3 of ECU group #1. That is, within five seconds since transmission of the SLEEP values of all ECUs, whenever at least one ECU switches to the ALIVE state, the relevant information, that is, the number of occurrences of switching into the ALIVE state is recorded.

In response to the preset time (e.g., forty minutes) allocated for the communication monitoring elapsing (YES in operation 318), the controller 102 transmits the result of the communication monitoring up to the present time, that is, the monitoring information, to the server 190, and then terminates the communication monitoring (320).

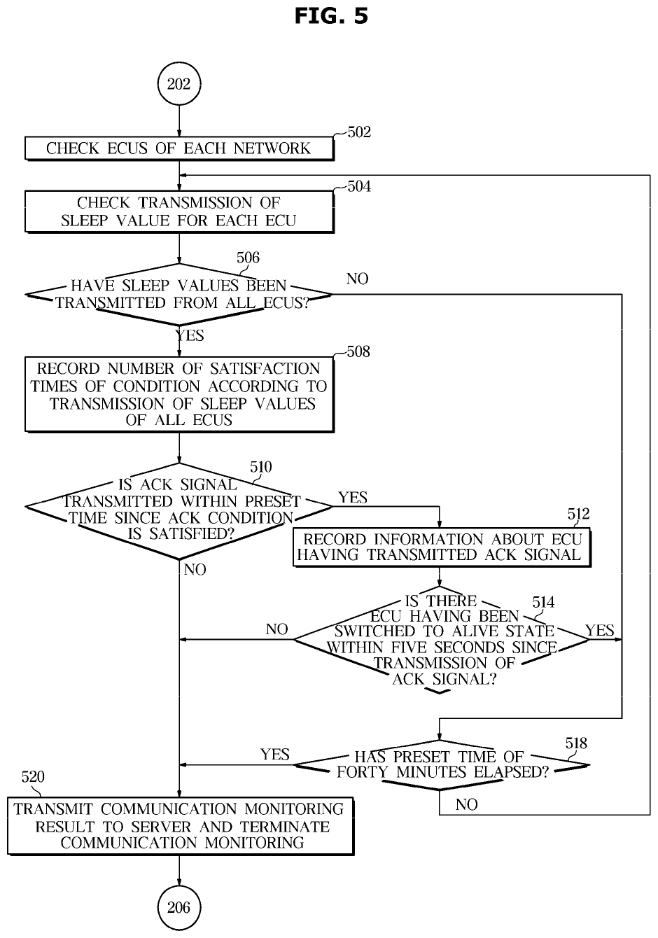

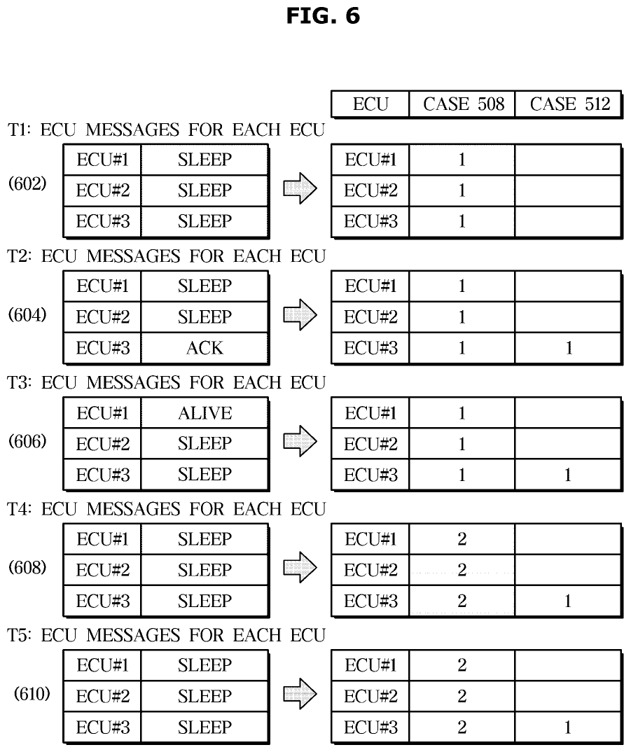

FIGS. 5 and 6 are diagrams illustrating another example of ‘performing communication monitoring and transmitting monitoring information’ in the method shown in FIG. 2. FIG. 5 is a diagram showing a method of detecting an ECU of a second type of error. That is, FIG. 5 shows a method of detecting a type of error in which all ECUs of one ECU group transmit SLEEP values of the network management message, but the last ECU does not transmit an ACK signal. FIG. 6 is a diagram illustrating network message values for each ECU and state information records during performance of the control method shown in FIG. 5.

Referring to FIG. 5, the controller 102 starts communication monitoring when all of the communication monitoring start conditions are satisfied by checking ECUs of each network as a first task of the communication monitoring (502). That is, through monitoring of a network management message, the existence of ECUs for each network or ECUs constituting each ECU group is checked.

In response to presence of ECUs for each network being confirmed, the controller 102 checks whether a SLEEP value for each ECU has been transmitted (504). First, the following description will be made in relation to an example in which the checking is performed on ECU #1 to ECU #3 of ECU group #1 shown in FIG. 1. That is, transmission of a SLEEP value is checked on each of ECU #1 to ECU #3 in ECU group #1.

In this case, the controller 102 checks whether the SLEEP values have been transmitted from all ECUs of ECU group #1, which is the monitoring target (506).

Based on transmission of the SLEEP values from all ECUs of ECU group #1 being confirmed (YES in operation 506), the controller 102 records the number of satisfaction times of a response signal generation condition according to the transmission of the SLEEP values of all ECUs (508). In FIG. 6, each number in item “CASE 508” is the number of times that each of ECU #1 to ECU #3 in ECU group #1 has transmitted a SLEEP value. That is, whenever each ECU transmits a SLEEP value, the number of transmission times is recorded. It can be seen that SLEEP values are transmitted from all ECUs in operation 602 of FIG. 6.

When all ECUs of ECU group #1 do not transmit the SLEEP value (‘No’ in operation 506), the controller 102 keeps checking a transmission of a SLEEP value for each ECU for a preset time (e.g., forty minutes) allocated for communication monitoring (318). Based on the preset time of forty minutes elapsing (YES in operation 318), the controller 102 transmits the communication monitoring result, that is, monitoring information up to the present time, to the server 190, and then terminates the communication monitoring (320).

Next, the controller 102 checks whether each ECU transmits an ACK signal within a preset time while the response signal generation condition is satisfied according to the transmission of the SLEEP values of all ECUs (510).

When an ACK signal is not transmitted in any ECU within a preset time while the response signal generation condition is satisfied according to transmission of SLEEP values of all ECUs (No in operation 510), the controller 102 transmits the communication monitoring result up to the present time, that is, monitoring information, to the server 190, and terminates the communication monitoring (520).

Conversely, in response to presence of at least one ECU that transmits an ACK signal within a preset time while the response signal generation condition is satisfied according to transmission of SLEEP values of all ECUs (YES in operation 510), the controller 102 records information about the corresponding ECU that has transmitted the ACK signal (512). In FIG. 6, the number of transmissions of an ACK signal from an ECU within a preset time, while the response signal generation condition is satisfied according to the transmission of the SLEEP values of all ECUs is shown. That is, the number of transmissions of an ACK signal of an ECU within a preset time, while the response signal generation condition is satisfied according to the transmission of the SLEEP values of all ECUs is recorded. Referring to FIG. 6, subsequent to operation 602, in which all ECUs have transmitted the SLEEP values, ECU #3 transmits an ACK signal in operation 604, so that the number of transmissions of the ACK signal is recorded as ‘1’ in item of “CASE 512” in operation 604.

Next, the controller 102 checks whether there is an ECU that has been switched to an ALIVE state within a preset time (e.g., five seconds) since the transmission of the ACK signal among the ECUs that have transmitted the ACK signals (514).

In response to absence of an ECU having been switched to an ALIVE state within the preset time (e.g., five seconds) since the transmission of the ACK signal (No in operation 514), the controller 102 transmits the communication monitoring result up to the present, that is, the monitoring information to the server 190, and terminates the communication monitoring (520).

Conversely, in response to presence of an ECU that has been switched to an ALIVE state within the preset time (e.g., five seconds) since the transmission of the ACK signal (YES in operation 514), the controller 102 keeps checking transmission of the SLEEP value of each ECU for a preset time (e.g., forty minutes) allocated for communication monitoring.

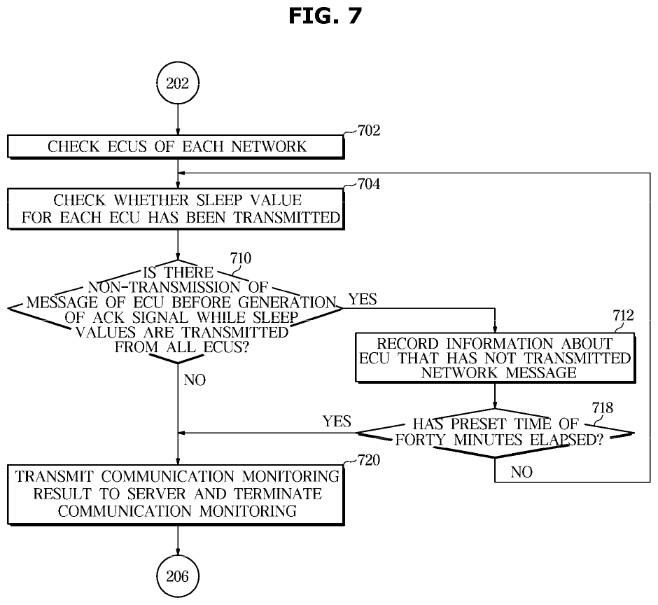

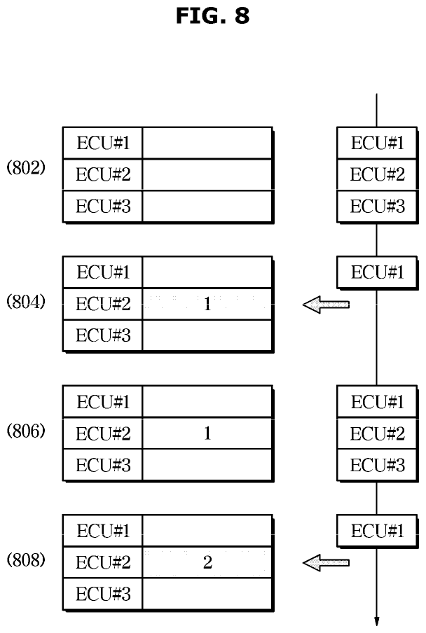

FIGS. 7 and 8 are diagrams illustrating another example of ‘performing communication monitoring and transmitting monitoring information’ in the method shown in FIG. 2. FIG. 7 is a diagram showing a method of detecting an ECU of a third type of error. That is, FIG. 7 shows a method of detecting a type of error in which a specific ECU in one ECU repeats transmission/non-transmission of a network management message so that the ECUs of the corresponding ECU group are repeatedly changed to an ALIVE state for network reconfiguration. FIG. 8 is a diagram illustrating records of information about an ECU that has not transmitted an ACK signal during the performance of the control method shown in FIG. 7.

Referring to FIG. 7, the controller 102 starts communication monitoring when all of the communication monitoring start conditions are satisfied by checking ECUs of each network as a first task of the communication monitoring (702). That is, through monitoring of a network management message, the existence of ECUs for each network or ECUs constituting each ECU is checked.

In response to presence of ECUs for each network being confirmed, the controller 102 checks whether a SLEEP value for each ECU has been transmitted (704). First, the following description will be made in relation to an example in which the checking is performed on ECU #1 to ECU #3 of ECU group #1 shown in FIG. 1. That is, transmission of a SLEEP value is checked on each of ECU #1 to ECU #3 in ECU group #1.

Next, the controller 102 checks whether a specific ECU has not transmitted a network message before generation of the ACK signal, while the SLEEP values are transmitted from all ECUs (710).

In response to absence of an ECU that has not transmitted a network message before generation of the ACK signal, while the SLEEP values are transmitted from all ECUs (No in operation 710), the controller 102 transmits the communication monitoring result up to the present, that is, monitoring information, to the server 190, and terminates communication monitoring (720).

Conversely, in response to presence of at least one ECU that has not transmitted a network message before generation of the ACK signal, while the SLEEP values are transmitted from all ECUs (YES in operation 710), the controller 102 records information about the ECU that has not transmitted a network message (712). FIG. 8 illustrates a record of the number of non-transmission times (the accumulated number ‘two’) that ECU #2 has not transmitted a network message before generation of an ACK signal while the SLEEP values have transmitted from all ECUs. As shown in FIG. 8, all ECUs have finally transmitted SLEEP values in operation 802, but it can be seen that in operation 804, ECU #1 has transmitted an ACK signal while ECU #2 has not transmitted a network message. Accordingly, the controller 102 records that ECU #2 has not transmitted a network message (the number of times “1” in item 804). Next, the controller 102 newly configures a network for all ECUs of ECU group #1 (806), and checks transmission of a network message of each ECU (806). However, as shown in item 808, if ECU #2 does not transmit a network message again, the controller 102 records once again that ECU #2 has not transmitted a network message. The number ‘2’ shown in item 808 in FIG. 8 is an accumulated value of the number of non-transmission times of a network message of ECU #2.

The controller 102 keeps checking transmission of the SLEEP value of each ECU for a preset time (e.g., forty minutes) allocated for the communication monitoring (718). In response to the preset time of forty minutes elapsing (YES in operation 718), the controller 102 transmits the communication monitoring result up to the present time, that is, the monitoring information, to the server 190, and then terminates the communication monitoring (720).

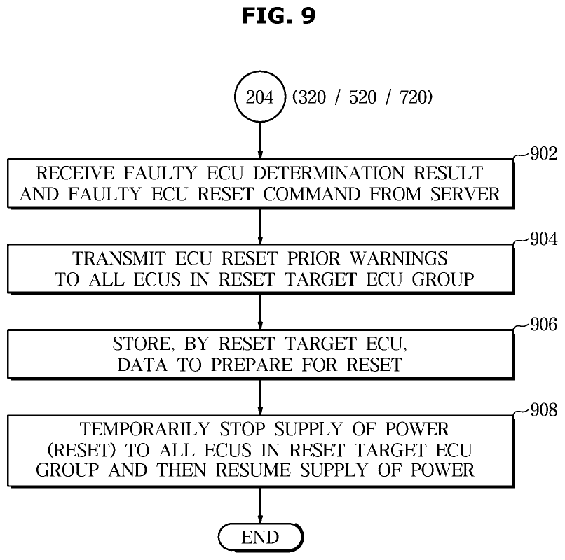

FIG. 9 is a diagram illustrating discharge prevention in a method of controlling a vehicle according to an embodiment of the disclosure. That is, in FIG. 9, ‘receiving an analysis result of monitoring information and performing a discharge prevention measure based on the analysis result’ of FIG. 2 is shown in detail.

When communication monitoring is performed in the vehicle 100 and monitoring information, as a result of the communication monitoring, is transmitted to the server 190, and the server 190 analyzes the communication monitoring result to identify the cause of a fault of a faulty ECU. The analysis result of the server 190 is transmitted to the controller 102 of the vehicle 100. The controller 102 of the vehicle 100 performs a measure for preventing discharge based on the analysis result received from the server 190. Details thereof will be described as follows.

Referring to FIG. 9, the controller 102 receives a result of determining a faulty ECU and a faulty ECU reset command from the server 190 (902). Such a faulty ECU reset command received from the server 190 is generated based on the analysis of the network communication monitoring result performed by the controller 102 of the vehicle 100.

The reset of a faulty ECU may be performed only on the faulty ECU or all ECUs of the ECU group to which the faulty ECU belongs. In the embodiment of the disclosure, the reset is performed on all ECUs of the ECU group to which the faulty ECU belongs.

The controller 102 transmits an ECU reset prior warning to all ECUs in a reset target ECU group, which is to be subject to the reset, before the reset is actually performed (904). The ECUs having received the ECU reset prior warning store data generated up to the present time, as a process of preparing for the reset (906). Each ECU preferably stores the data in a non-volatile memory so that the data is preserved even when power is cut off by the reset.

After such an advance measure of the reset target ECUs before the reset, the controller 102 transmits a reset command to the power supply 106, and in response to the reset command transmitted from the controller 102, the power supply 106 temporarily stops the supply of power to the reset target ECU and then resumes the supply of power (908). The reset target ECU may be reset by the stop of the supply of power to the reset target ECU, and followed by the resumption of the supply of power the corresponding ECUs may start operation in an initialized state.

Such a series of processes may prevent battery consumption and battery discharge from occurring when all ECUs connected to a network do not switch to a SLEEP state due to an error in a specific ECU among the ECUs.

As is apparent from the above, the vehicle and the method of controlling the same according to the disclosure can detect a faulty ECU that fails to be switched to a sleep mode and allow the faulty ECU to be normally switched to a sleep mode by resetting the faulty ECU, thereby preventing a battery discharge.

The above description of the present disclosure is for illustrative purposes, and a person having ordinary skilled in the art should appreciate that other specific modifications may be easily made without departing from the technical spirit or essential features of the present disclosure. Therefore, the above embodiments should be regarded as illustrative rather than limitative in all aspects. The scope of the disclosure is not to be limited by the detailed description set forth above, but by the accompanying claims of the present disclosure, and it should in addition be understood that all changes or modifications derived from the definitions and scope of the claims and their equivalents fall within the scope of the present disclosure.

What is claimed is:

1. A method of controlling a vehicle, the method comprising:
performing, by a controller, communication monitoring on a plurality of electronic control units (ECUs) connected to each other through a network;
detecting, by the controller, a faulty ECU that does not enter a sleep mode under a sleep mode entry condition from among the plurality of ECUs based on a result of the communication monitoring; and
performing, by the controller, a reset on the faulty ECU to allow the faulty ECU to enter the sleep mode.

2. The method of claim 1, wherein an ECU that does not transmit a signal indicating a SLEEP value of a network management message or alternately transmits a signal indicating the SLEEP value and a signal indicating an ALIVE value of the network management message is determined as the faulty ECU.

3. The method of claim 1, wherein if the plurality of ECUs transmit a signal indicating a SLEEP value of a network management message, and a last ECU among the plurality of ECUs does not transmit an ACK signal, the last ECU is determined as the faulty ECU.

4. The method of claim 1, wherein if at least one ECU among the plurality of ECUs repeats transmission and non-transmission of a network management message so that the plurality of ECUs repeatedly change to an ALIVE state for network reconfiguration therebetween, the at least one ECU is determined as the faulty ECU.

5. The method of claim 1, wherein the plurality of ECUs form one ECU group, and the performing of the reset on the fault ECU includes performing a reset on all ECUs in the one ECU group to which the fault ECU belongs.

6. The method of claim 5, wherein the performing of the reset on the fault ECU includes temporarily stopping a supply of power to reset target ECUs to be subject to the reset and then resuming the supply of power.

7. The method of claim 1, further comprising, before the performing of the reset, transmitting a reset warning to a reset target ECU to be subject to the reset.

8. The method of claim 7, further comprising, in response to the reset warning, allowing data of the reset target ECU to be stored.

9. The method of claim 1, wherein the performing of the communication monitoring is started when a preset communication monitoring start condition is satisfied.

10. The method of claim 9, wherein the preset communication monitoring start condition includes:
a state in which an engine of the vehicle is turned off;
a state in which a door of a driver seat is closed after having been opened;
a state in which all doors of the vehicle are locked; and
a battery voltage of the vehicle is greater than or equal to a predetermined voltage.

11. A vehicle comprising:
a plurality of electronic control units (ECUs) connected to each other through a network to form one ECU group; and
a controller configured to perform communication monitoring on the plurality of ECUs, detect a faulty ECU that does not enter a sleep mode under a sleep mode entry condition from among the plurality of ECUs based on a result of the communication monitoring, and perform a reset on the faulty ECU to allow the faulty ECU to enter the sleep mode.

12. The vehicle of claim 11, wherein the controller is configured to determine an ECU that does not transmit a signal indicating a SLEEP value of a network management message or alternately transmits a signal indicating the SLEEP value and a signal indicating an ALIVE value of the network management message as the faulty ECU.

13. The vehicle of claim 11, wherein the controller is configured to, if the plurality of ECUs transmit a signal indicating a SLEEP value of a network management message, and a last ECU among the plurality of ECUs does not transmit an ACK signal, determine the last ECU as the faulty ECU.

14. The vehicle of claim 11, wherein the controller is configured to, if at least one ECU among the plurality of ECUs repeats transmission and non-transmission of a network management message so that the plurality of ECUs repeatedly change to an ALIVE state for network reconfiguration therebetween, determine the at least one ECU as the faulty ECU.

15. The vehicle of claim 11, wherein the reset on the faulty ECU is performed by resetting all ECUs in the one ECU group to which the fault ECU belongs.

16. The vehicle of claim 15, wherein the reset on the faulty ECU is performed by temporarily stopping a supply of power to reset target ECUs to be subject to the reset and then resuming the supply of power.

17. The vehicle of claim 11, wherein the controller is configured to, before the reset, transmit a reset warning to a reset target ECU to be subject to the reset.

18. The vehicle of claim 17, wherein the controller is configured to, in response to the reset warning, allow data of the reset target ECU to be stored.

19. The vehicle of claim 18, wherein the controller is configured to perform the communication monitoring when a preset communication monitoring start condition is satisfied.

20. The vehicle of claim 19, wherein the preset communication monitoring start condition includes:
a state in which an engine of the vehicle is turned off;
a state in which a door of a driver seat is closed after having been opened;
a state in which all doors of the vehicle are locked; and
a battery voltage of the vehicle is greater than or equal to a predetermined voltage.
